(19) United States
(12) Patent Application Publication
(10) Pub. No.: US 2007/0272248 A1
(43) Pub. Date: Nov. 29, 2007

(54) Elastic nonwoven face mask

(76) Inventor: Flora Lin, Jhu Dong (TW)

Correspondence Address: RABIN & Berdo, PC, 1101 14TH STREET, NW, SUITE 500, WASHINGTON, DC, 20005, US

(21) Appl. No.: 11/413,181

(22) Filed: Apr. 28, 2006

(51) Int. Cl. A62B 18/02

(52) U.S. Cl. 128/206.28

(57) ABSTRACT

The invention is to provide an elastic nonwoven mask comprised of a butterfly folded filtration portion, two integrated loops, and a folding ridge with identical upper and lower fold curve being symmetrical to the central point of the folding ridge. The filtration portion includes at least one layer of elastic nonwoven fabric, and the integrated loops are extended from the filtration portion on two ends. The upper and lower sides of mask are identical for the convenience of fitting onto the wearers' nose-line without the necessity of distinguishing the upper curve for nose and the lower curve for chin.

### FIELD OF THE INVENTION

The invention relates to a face mask made with elastic nonwoven fabric, and more specifically, to a butterfly folded elastic nonwoven mask having a filter portion and integrated loops. The curve of the folding ridge of the filter portion is symmetric to its own center point.

### BACKGROUND OF THE INVENTION

The title of U.S. Pat. No. 6,615,838 “Disposable Face Mask” describes a face mask made with elastic nonwoven fabric including a butterfly folded filtration portion and integrated loops on two ends. When in use, the opening of the folded filtration portion covers the face of the wearer and the integrated loops provide the purpose of fastening on the wearer's ears. This conventional mask was designed with an asymmetric folding ridge to comply to the curve of the wearer's nose-line from the bridge of the nose to the chin; however in reality, each wearer has a different nose-line curve and proportion, and the asymmetric folding ridge usually causes the upside-down confusion and the inconvenience of fitting the mask to the face.

### SUMMARY

The object of the invention is to provide a butterfly folded elastic nonwoven mask having a symmetrical folding ridge to fit the nose-line of the wearer without the necessity of distinguishing the upper or lower side in fitting it to the face.

To achieve the foresaid object, the invention is to provide a mask made with elastic nonwoven fabric comprised of a butterfly folded filtration portion with integrated loops on two ends, wherein the filtration portion is composed of at least one layer of elastic fabric configured to cover the mouth and at least part of the nose of the wearer. The integrated loops extend from the filter portion to fasten around the wearer's ears, the upper and lower curve of the folding ridge of the filtration portion are symmetrical to the central point of the folding ridge; therefore, the finished mask has no distinguishable upper or lower side.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is the exploded view of the first preferred embodiment in accordance with the invention;

FIG. 2 is the perspective view of the first preferred embodiment in accordance with the invention;

FIG. 3 is the perspective view of the first preferred embodiment fitted into wearer's face in accordance with the invention; and

FIG. 4 is the perspective view of the second preferred embodiment fitted into wearer's face in accordance with the invention.

### DESCRIPTION OF THE PREFERRED EMBODIMENT

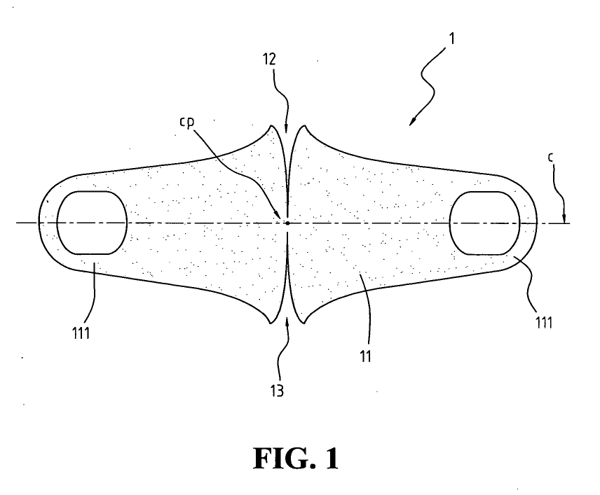

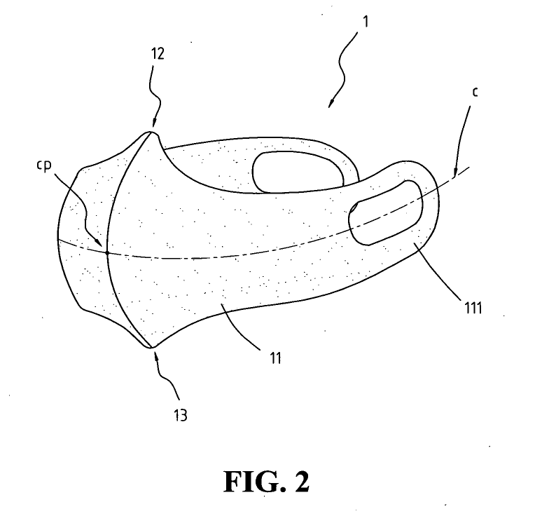

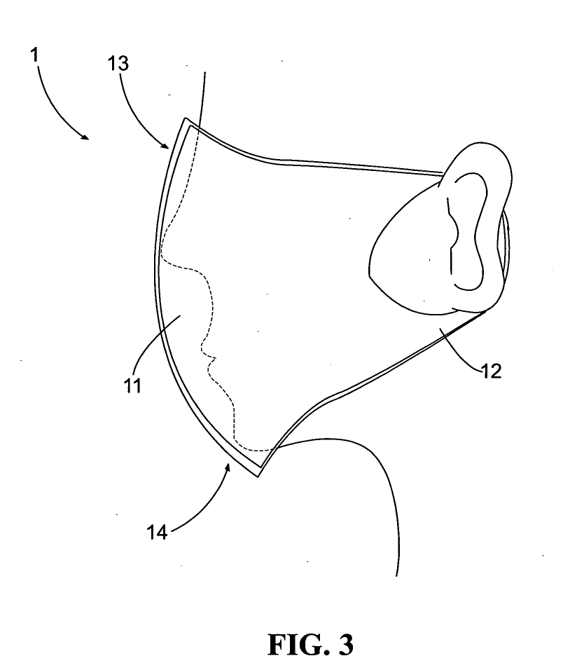

With reference to FIG. 1, it shows the exploded view of the first preferred embodiment in accordance with the invention. An opened elastic nonwoven mask is comprised of a filtration portion 11, integrated loops 111 on two ends with any shape of opening that is symmetrical to the central line, and the upper curve 12 and lower curve 13 that are identical and symmetric to the center point of the folding ridge CP, wherein the configuration of the upper and lower portion of the opened mask are also symmetric and identical according to the horizontal central line C. The filtration portion 11 can be butterfly folded along the vertical folding ridge to become a finished mask. FIG. 2 shows a finished mask that the upper folding curve 12 and the lower folding curve 13 are sewed to form a completely sealed central folding ridge. The integrated loops 111 are extended from the butterfly folded filtration portion with any shape of opening that is symmetrical to the central line. The symmetry of the upper 12 and the lower folding curve 13 illustrated in FIG. 2 makes the finished mask undistinguishable between upper and lower sides and it shows the perspective view of the first preferred embodiment in accordance with the invention. FIG. 3 is the perspective view of the first preferred embodiment fitted onto the wearer's face in accordance with the invention, and the symmetry of the upper 12 and the lower folding curve 13 are to fit onto wearer's face without the necessity of distinguishing an upper side for nose and a lower side for chin.

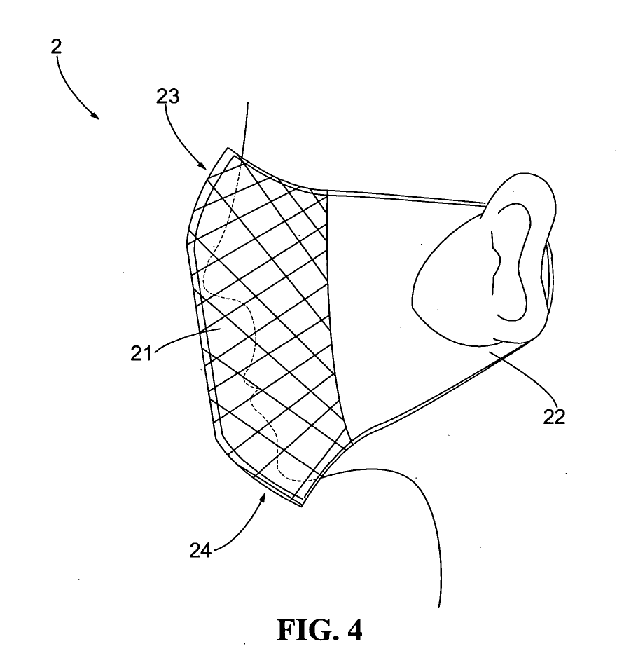

Furthermore, referring to FIG. 4, the perspective view of the second preferred embodiment fitted onto the wearer's face. The butterfly-folded elastic nonwoven mask is comprised of a multiple-layer filter portion 21, integrated loops on two ends 211 with any shape of opening that is symmetrical to the central line, and the folding ridge being formed with a section of straight line and the upper curve 22 and lower curve 23 of the folding ridge being identical and symmetrical to the central point of folding ridge.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the proposition and scope of the invention, as set forth in the following claims.

What is claimed is:

1. A elastic nonwoven mask with butterfly folded, comprising
(a) a symmetrically folded filtration portion constructed with at least one layer of elastic nonwoven fabric;
(b) integrated loops extended from the filtration portion on two ends with any shape of opening that is symmetrical to the central line;
(c) an upper folding curve sealing at least part of the upper folding ridge of the filtration portion; and
(d) a lower folding curve sealing at least part of the lower folding ridge of the filtration portion;
wherein the upper folding curve and the lower folding curve are identical to each other and symmetric to the central point of the folding ridge.

2. The elastic nonwoven mask of claim 1, wherein the upper folding curve and the lower folding curve are sewed to seal the whole upper and the whole lower central folding ridge of the filtration portion.

3. The elastic nonwoven mask of claim 1, wherein the filtration portion is a multiple-layer construction.

4. The elastic nonwoven mask of claim 1, wherein the folding ridge is configured with a section of straight line and two identical upper and lower curves.

5. The elastic nonwoven mask of claim 2, wherein the filtration portion is a multiple-layer construction.

6. The elastic nonwoven mask of claim 2, wherein the folding ridge is configured with a section of straight line and two identical upper and lower curves.
